(19) United States
(12) Patent Application Publication
(10) Pub. No.: US 2026/0186498 A1
(43) Pub. Date: Jul. 2, 2026

(54) CONTROL DEVICE

(71) Applicant: NTT DOCOMO, INC., Tokyo (JP)

(72) Inventors: Masaki MORISHITA, Tokyo (JP); Hiroki ISHIZUKA, Tokyo (JP); Masashi ANZAWA, Tokyo (JP); Keisuke NAKASHIMA, Tokyo (JP)

(21) Appl. No.: 18/864,923

(22) PCT Filed: Apr. 25, 2023
(86) PCT No.: PCT/JP2023/016261

§ 371 Date: Nov. 12, 2024

(30) Foreign Application Priority Data
May 30, 2022 (JP) 2022-087987

(51) Int. Cl. G05D 1/622; G05D 1/667; G05D 105/20; G05D 109/20; G05D 111/20; G10L 15/00

(52) U.S. Cl. CPC G05D 1/622; G05D 1/667; G10L 15/00; G05D 2105/20; G05D 2109/20; G05D 2111/20

(57) ABSTRACT

Estimation unit estimates whether or not there is a person inside of a door based on sound data obtained by obtaining unit. Here, “inside of a door” refers to a space in which a user takes off his shoes at an entrance and a space from which the user who has taken off his shoes enters a room. Setting unit sets a prohibited entry range for drone with reference to the position of the door. More specifically, when it is estimated that there is a person inside of the door, setting unit sets the prohibited entry range larger than when it is estimated that there is no person inside of the door.

### TECHNICAL FIELD

The present invention relates to a technology for delivering a parcel to a destination by use of a flight vehicle.

### BACKGROUND

With the widespread use of unmanned flight vehicles, referred to as “drones,” various systems have been proposed that utilize drones for delivery of parcels. For example, Japanese Patent No. 6622291 discloses a system in which a landing pad is provided in a landing zone of a delivery destination of a drone, and the drone is guided to the landing pad by use of a visual assistance apparatus, an optical assistance apparatus, or a radio assistance apparatus.

### SUMMARY OF INVENTION

The system described in Japanese Patent No. 6622291 is subject to a problem in that a landing pad, which is a dedicated facility, is required to be provided at each destination to which parcels are delivered. Accordingly, convenience can be improved if a vacant space in front of an entrance or a doorway can be recognized and a parcel delivered to the space.

However, when a flight vehicle is placing a parcel in such a space, if a person inside of a door opens the door and comes out without noticing the flight vehicle flying close to the door, there is a risk that the person may collide with the flight vehicle.

In view of the foregoing, an object of the present invention is to prevent a person from colliding with a flight vehicle that is outside a door when the person inside of the door comes outside of the door.

The present invention provides a control apparatus including: an obtaining unit configured to obtain a result of sound detection outside a door situated at a destination of a flight vehicle; an estimation unit configured to estimate whether a person is inside of the door based on the obtained result of sound detection; and a setting unit configured to set a prohibited entry range for the flight vehicle based on a position of the door, wherein, when it is estimated that the person is inside of the door, the setting unit increases the prohibited entry range compared to when it is estimated that there is no person inside of the door.

According to the present invention, it is possible to prevent a person from colliding with a flight vehicle that is outside a door when the person inside of the door comes outside of the door.

### BRIEF DESCRIPTION OF DRAWINGS

FIG. 1 is a block diagram showing an example of a configuration of drone control system 1 according to an embodiment of the present invention.

FIG. 2 is a block diagram showing an example of a hardware configuration of drone 10 according to the embodiment.

FIG. 3 is a block diagram showing an example of a hardware configuration of server apparatus 50 according to the embodiment.

FIG. 4 is a block diagram showing an example of a functional configuration of drone 10 according to the embodiment.

FIG. 5 is a diagram showing an example of a movable range of a sliding door.

FIG. 6 is a diagram showing an example of a movable range of a door that opens inward.

FIG. 7 is a diagram showing an example of a movable range of a door that opens outward and rightward.

FIG. 8 is a diagram showing an example of a movable range of a door that opens outward and leftward.

FIG. 9 is a diagram showing an example of movable ranges of doors that open outward and leftward and rightward respectively.

FIG. 10 is a diagram showing an example of a prohibited entry range set for a sliding door.

FIG. 11 is a diagram showing an example of a prohibited entry range set for a door that opens inward.

FIG. 12 is a diagram showing an example of a prohibited entry range set for a door that opens outward.

FIG. 13 is a diagram showing an example of sizes of prohibited entry ranges for a drone.

FIG. 14 is a diagram showing an example of sizes of prohibited entry ranges for a drone.

FIG. 15 is a flowchart showing an example procedure of processing performed by drone 10 according to the embodiment.

FIG. 16 is a diagram showing an example of door information stored in server apparatus 50 in a modification example.

### DETAILED DESCRIPTION

### Configuration

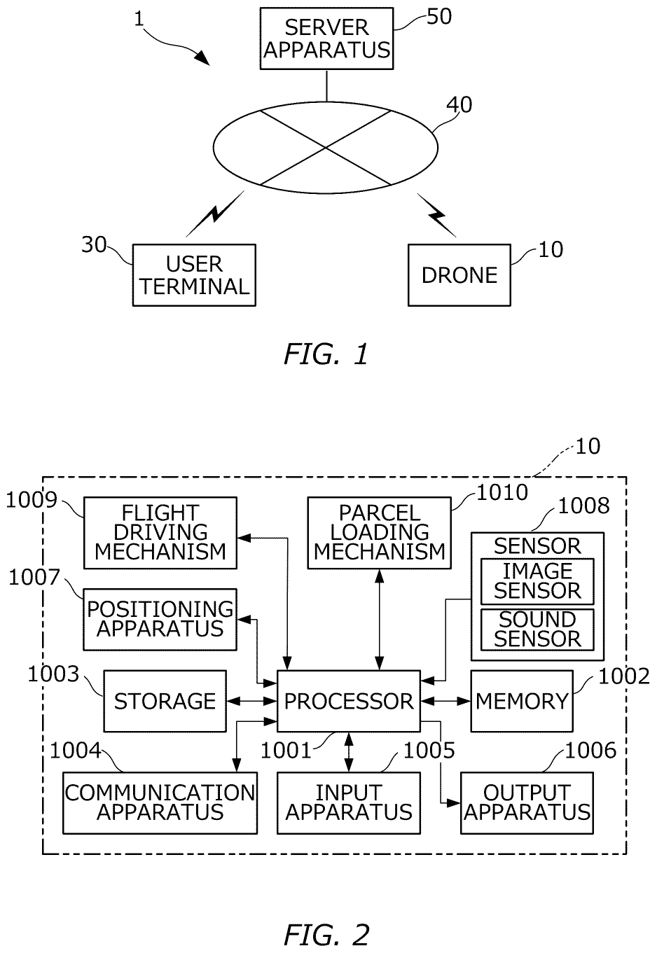

FIG. 1 is a block diagram showing an example of a configuration of drone control system 1 according to an embodiment of the present invention. Drone control system 1 includes drone 10 that flies in the air and delivers a parcel to a destination, user terminal 30 used by a user to whom the parcel is delivered, wireless communication network 40, and server apparatus 50 connected to wireless communication network 40. Wireless communication network 40 is a system that realizes wireless communication and may be a facility that conforms to a 4G mobile communication system or a facility that conforms to a 5G mobile communication system, for example. Note that FIG. 1 shows one drone 10, one user terminal 30, one wireless communication network 40, and one server apparatus 50, but the number of each of these elements may also be two or more.

Drone 10 is an unmanned flight vehicle that flies in the air. Drone 10 flies from a departure-arrival site that is called a base, a depot, or the like to a destination while holding a parcel, and delivers the parcel to the destination by landing at the destination.

User terminal 30 is a computer that can perform communication, such as a smartphone, a tablet, or a personal computer. In the present embodiment, user terminal 30 is a smartphone and functions as a communication terminal that a user who receives the parcel uses to access server apparatus 50 via wireless communication network 40.

Server apparatus 50 stores flight plan information regarding a flight date and time, a flight route, and a flight altitude of drone 10 and parcel information regarding the parcel delivered by drone 10, for example, and performs remote control of drone 10 in accordance with the flight plan information. The remote control is performed by server apparatus 50 mainly between the departure-arrival site described above and the sky above a destination of drone 10 or between a plurality of destinations of drone 10. Drone 10 flies under autonomous control performed by itself between the sky above the destination and a landing position for drone 10. Specifically, drone 10 performs unloading operations by determining a landing position at the destination, landing at the landing position, and detaching the parcel, and again rises up to the sky above the destination. Thereafter, drone 10 flies to the departure-arrival site or the next destination under remote control performed by server apparatus 50.

In the present embodiment, drone 10 flies under the remote control performed by server apparatus 50 between the departure-arrival site of drone 10 and the sky above the destination, and autonomously flies between the sky above the destination and the landing position for drone 10 as described above, but there is no limitation to this example. For example, drone 10 may autonomously fly throughout its route between the departure-arrival site and the landing position at the destination independently of the remote control performed by server apparatus 50, or may fly under the remote control performed by server apparatus 50 throughout its route between the departure-arrival site and the landing position at the destination.

In view of the labor of the user when the user collects the parcel delivered to the destination, it is desirable to deliver the parcel to a position as close as possible to a door provided at an entrance or a doorway of the destination. However, if the parcel is delivered to a position close to the door, when the user inside the destination opens the door and comes out abruptly, the user may collide with drone 10 that is flying to deliver the parcel or the delivered parcel.

Therefore, in the present embodiment, a certain range is set with reference to the position of the door provided at the destination of drone 10 as a prohibited entry range for which entry of drone 10 is prohibited. When there is a person inside of the door (e.g., next to the door in a building at the destination), the prohibited entry range is set larger than when there is no person inside of the door (e.g., next to the door in the building at the destination). Thus, the above-described collision between the user and drone 10 or the parcel is avoided.

FIG. 2 is a diagram showing an example of a hardware configuration of drone 10. Drone 10 is physically configured as a computer apparatus that includes processor 1001, memory 1002, storage 1003, communication apparatus 1004, input apparatus 1005, output apparatus 1006, positioning apparatus 1007, sensor 1008, flight driving mechanism 1009, parcel loading mechanism 1010, and a bus connecting these elements, and the like. Note that in the following description, the term “apparatus” may be read as a circuit, a device, a unit, or the like. The hardware configuration of drone 10 may be configured to include one or more pieces of each illustrated apparatus, or so as not to include some of the apparatuses.

Each function of drone 10 is realized by loading predetermined software (program) into hardware such as processor 1001 or memory 1002 to perform computation by processor 1001, control communication performed by communication apparatus 1004, control at least one of data reading from and data writing into memory 1002 and storage 1003, and control positioning apparatus 1007, sensor 1008, flight driving mechanism 1009, and parcel loading mechanism 1010.

Processor 1001 controls the entire computer by activating an operating system, for example. Processor 1001 may also be constituted by a central processing unit (CPU) that includes an interface with peripheral apparatuses, a control apparatus, a computation apparatus, a register, and the like. Also, a baseband signal processing unit, a call processing unit, or the like may be realized by processor 1001.

Processor 1001 reads a program (program code), a software module, data, or the like from at least one of storage 1003 and communication apparatus 1004 to memory 1002 and executes various types of processing based thereon. As the program, a program for causing the computer to execute at least some of operations described later is used. Functional blocks of drone 10 may also be realized by a control program that is stored in memory 1002 and runs in processor 1001. Various types of processing may be executed by one processor 1001 or may be executed by two or more processors 1001 at the same time or successively. Processor 1001 may also be implemented by one or more chips. Note that the program may also be transmitted via wireless communication network 40 to drone 10.

Memory 1002 is a computer-readable recording medium, and may be constituted by at least one of, for example, a ROM, an erasable programmable ROM (EPROM), an electrically erasable programmable ROM (EEPROM), a RAM, and the like. Memory 1002 may also be referred to as a register, a cache, a main memory (main storage apparatus), or the like. Memory 1002 can store a program (program code), a software module, and the like that can be executed to perform a method according to the present embodiment.

Storage 1003 is a computer-readable recording medium, and may be constituted by at least one of, for example, an optical disk such as a compact disc ROM (CD-ROM), a hard disc drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disc, a magnetic strip, and the like. Storage 1003 may also be referred to as an auxiliary storage apparatus. Storage 1003 stores various programs and data groups.

Processor 1001, memory 1002, and storage 1003 described above function as an example of a control apparatus according to the present invention.

Communication apparatus 1004 is a piece of hardware (a transmitting and receiving device) for performing communication with a computer via wireless communication network 40, and is also referred to as, for example, a network device, a network controller, a network card, a communication module, or the like. Communication apparatus 1004 includes a high-frequency switch, a duplexer, a filter, a frequency synthesizer, and the like to realize frequency division duplexing and time division duplexing. A transmission and reception antenna, an amplification unit, a transmission and reception unit, a transmission path interface, and the like may be realized by communication apparatus 1004. The transmission and reception unit may be implemented as a transmission unit and a reception unit that are physically or logically separate from each other.

Input apparatus 1005 is an input device that accepts input from the outside and includes a key, a switch, a microphone, or the like, for example. Output apparatus 1006 is an output device for making output to the outside and includes a display apparatus such as a liquid crystal display, a speaker, or the like, for example. Note that input apparatus 1005 and output apparatus 1006 may also be integrated.

Positioning apparatus 1007 is a piece of hardware that measures the position of drone 10, and may be a global positioning system (GPS) device, for example. Drone 10 flies from the departure-arrival site to the sky above the destination based on positioning performed by positioning apparatus 1007.

Sensor 1008 includes a distance measuring sensor that functions as means for measuring the altitude of drone 10 and means for confirming conditions of a landing position, a gyroscopic sensor and an azimuth sensor that function as means for measuring the orientation of drone 10, an image sensor that functions as image capturing means, and a sound sensor that functions as sound collecting means, for example.

Flight driving mechanism 1009 is a mechanism used for the flight of drone 10 and includes pieces of hardware such as a motor, a shaft, a gear, and a propeller, for example.

Parcel loading mechanism 1010 is a mechanism for loading a parcel on drone 10 and detaching the parcel from drone 10 and includes pieces of hardware such as a motor, a winch, a wire, a gear, a lock mechanism, and a hanging mechanism, for example.

The apparatuses such as processor 1001 and memory 1002 are connected to each other via a bus for communicating information. The bus may be constituted by a single bus, or may be constituted by buses that are different between the apparatuses. Also, drone 10 may include pieces of hardware such as a microprocessor, a digital signal processor (DSP), an application specific integrated circuit (ASIC), a programmable logic device (PLD), and a field programmable gate array (FPGA), and some or all of the functional blocks may be realized by these pieces of hardware. For example, processor 1001 may be implemented with use of at least one of these pieces of hardware.

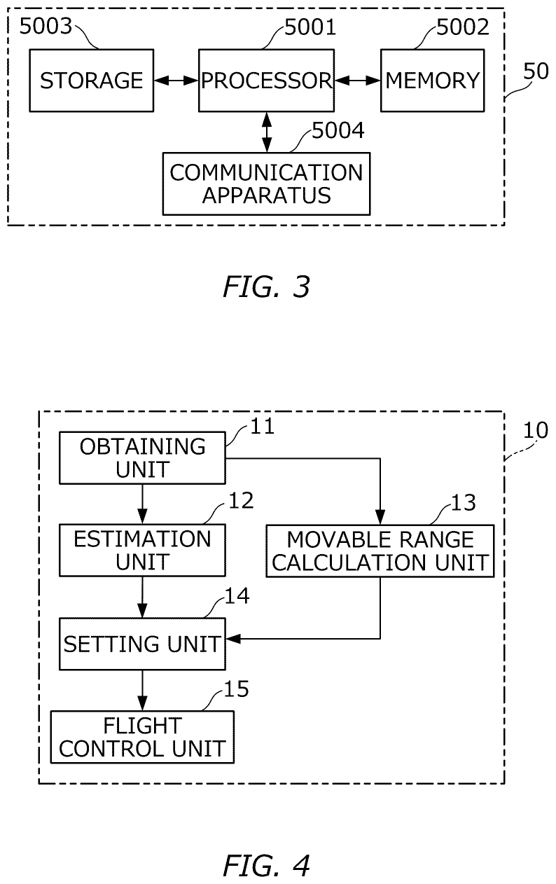

FIG. 3 is a diagram showing a hardware configuration of server apparatus 50. The hardware configuration of server apparatus 50 may be configured to include one or more pieces of each apparatus shown in FIG. 3, or so as not to include some of the apparatuses. Also, server apparatus 50 may be composed of a plurality of apparatuses having different housings and communicably connected to each other.

Server apparatus 50 is physically configured as a computer apparatus that includes processor 5001, memory 5002, storage 5003, communication apparatus 5004, a bus connecting these elements, and the like. Each function of server apparatus 50 is realized by loading predetermined software (program) into hardware such as processor 5001 or memory 5002 to perform computation by processor 5001, control communication performed by communication apparatus 5004, and control at least one of data reading from and data writing into memory 5002 and storage 5003. These apparatuses operate with power supplied from a power source (not shown). Note that in the following description, the term “apparatus” may be read as a circuit, a device, a unit, or the like.

Processor 5001 controls the entire computer by activating an operating system, for example. Processor 5001 may be constituted by a central processing unit (CPU) that includes an interface with peripheral apparatuses, a control apparatus, a computation apparatus, a register, and the like. Also, a baseband signal processing unit, a call processing unit, or the like may be realized by processor 5001.

Processor 5001 reads a program (program code), a software module, data, or the like from at least one of storage 5003 and communication apparatus 5004 to memory 5002 and executes various types of processing based thereon. As the program, a program for causing the computer to execute at least some of operations described later is used. Functional blocks of server apparatus 50 may also be realized by a control program that is stored in memory 5002 and runs in processor 5001. Various types of processing may be executed by one processor 5001, or may be executed by two or more processors 5001 at the same time or successively. Processor 5001 may also be implemented by one or more chips.

Memory 5002 is a computer-readable recording medium, and may be constituted by at least one of, for example, a ROM, an EPROM, an EEPROM, a RAM, and the like. Memory 5002 may also be referred to as a register, a cache, a main memory (main storage apparatus), or the like. Memory 5002 can store a program (program code), a software module, and the like that can be executed to perform the method according to the present embodiment.

Storage 5003 is a computer-readable recording medium, and may be constituted by at least one of, for example, an optical disk such as a CD-ROM, a hard disc drive, a flexible disc, a magneto optical disc (for example, a compact disc, a digital versatile disc, or a Blu-ray (registered trademark) disc), a smart card, a flash memory (for example, a card, a stick, or a key drive), a floppy (registered trademark) disc, a magnetic strip, and the like. Storage 5003 may also be referred to as an auxiliary storage apparatus. Storage 5003 stores at least a program and a data group for executing various types of processing described later.

Communication apparatus 5004 is a piece of hardware (a transmitting and receiving device) for performing communication with a computer via wireless communication network 40, and is also referred to as, for example, a network device, a network controller, a network card, a communication module, or the like.

The apparatuses such as processor 5001 and memory 5002 are connected to each other by a bus for communicating information. The bus may be constituted by a single bus, or may be constituted by buses that are different between the apparatuses.

Server apparatus 50 may also include pieces of hardware such as a microprocessor, a digital signal processor, an ASIC, a PLD, and an FPGA, and some or all of the functional blocks may be realized by these pieces of hardware. For example, processor 5001 may be implemented with use of at least one of these pieces of hardware.

Note that a hardware configuration of user terminal 30 includes units similar to those included in server apparatus 50 and an input apparatus and an output apparatus similar to those included in drone 10, as user interfaces.

FIG. 4 is a diagram showing an example of a functional configuration of drone 10. Drone 10 realizes functions such as obtaining unit 11, estimation unit 12, movable range calculation unit 13, setting unit 14, and flight control unit 15.

Obtaining unit 11 obtains various types of data from positioning apparatus 1007, sensor 1008, or server apparatus 50, for example. For example, obtaining unit 11 obtains instructions relating to remote control of drone 10 from server apparatus 50 via wireless communication network 40. Also, obtaining unit 11 obtains data to be used for setting a prohibited entry range when drone 10 delivers a parcel at the destination and determining a landing position from sensor 1008, for example. Specifically, this data includes image data obtained by an image sensor included in sensor 1008 by capturing an image of a space including a door provided at the destination and sound image data obtained by a sound sensor included in sensor 1008 by detecting sound outside the door provided at the destination.

Estimation unit 12 estimates whether or not there is a person inside of the door based on the sound data obtained by obtaining unit 11. Here, “inside of the door” refers to a space in which the user takes off his shoes at the entrance and a space from which the user who has taken off his shoes enters a room. That is to say, “inside of the door” refers to a space where the user is present just before opening the door to go out or just after returning from the outside. Estimation unit 12 analyzes the sound data obtained by obtaining unit 11, and upon detecting a sound generated due to action of a person, which includes speech of the user, with a sound volume larger than or equal to a certain threshold, estimates that there is a person inside of the door.

The content of speech (e.g., “I'm going” or “I'm back”) may differ between a user who is just before opening the door to go out and a user who has just returned from the outside. Therefore, estimation unit 12 recognizes the content of speech of a person who is inside of the door with an audio recognition technology based on sound data obtained by obtaining unit 11 and estimates whether or not the person will come outside of the door based on the recognized content of speech. Also, a sound generated due to action differs between a case where the user is taking off his shoes or clothing and a case where the user is putting on his shoes or clothing, and accordingly, estimation unit 12 may also perform the above-described estimation in view of such a difference in the sound generated due to action.

Movable range calculation unit 13 calculates a movable range in which the door provided at the destination of drone 10 opens and closes. Specifically, movable range calculation unit 13 detects the appearance or the shape of the door from the image data obtained by obtaining unit 11 with use of an analysis method such as pattern matching or feature value recognition, recognizes door information regarding the door from the detection result, and calculates the movable range of the door. The door information includes information regarding the position of the door, the size of the door, or an opening/closing mechanism of the door. The position of the door is a position of the door in a three-dimensional space. The size of the door is the length of each side of the door in the three-dimensional space. The position and the size of the door can be identified by calculating coordinate values in the three-dimensional space. The opening/closing mechanism of the door indicates a type of the mechanism such as whether the door is a sliding door or a hinged door, if the door is a hinged door, whether the door opens inward, outward, or both inward and outward, and if the door opens outward, whether the door opens rightward, leftward, or both rightward and leftward. It is possible to identify the opening/closing mechanism of the door by performing analysis to find out whether the shape of a doorknob of the door corresponds to a sliding door or a hinged door, whether the position of the doorknob corresponds to a door that opens rightward, a door that opens leftward, or a door that opens both rightward and leftward, whether or not a hinge provided along a side of the door can be observed from the outside of the building, or the position of the hinge relative to the door.

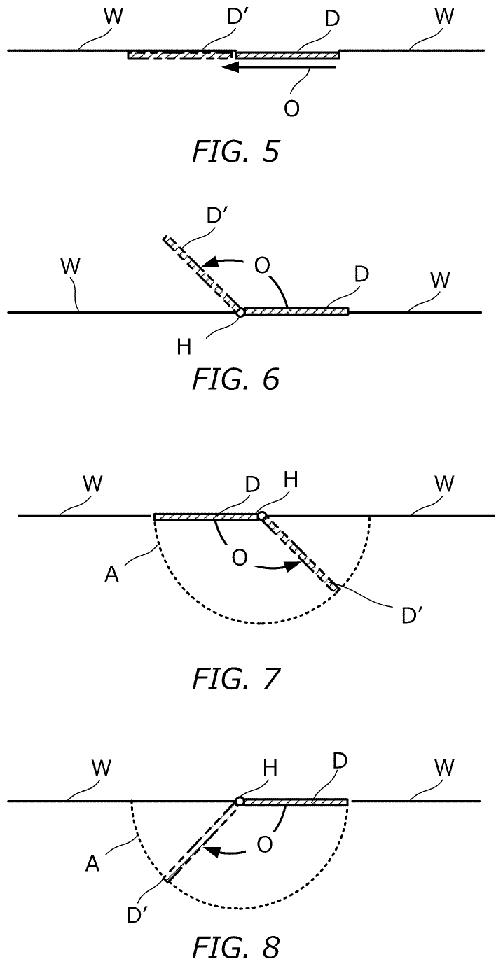

FIGS. 5 to 9 are diagrams showing examples of the movable range of the door for each opening/closing structure of the door. FIG. 5 is a plan view showing a space including door D and wall W as viewed from above and shows an example of the movable range of the door that is a sliding door. When closed door D is opened in the direction of arrow O to the position of door D′ shown in FIG. 5, the movable range of door D is linear.

FIG. 6 is a plan view showing a space including door D and wall W as viewed from above and shows an example of the movable range of the door that opens inward. Even when closed door D is opened in the direction of arrow O to the position of door D′ shown in FIG. 6, the movable range of door D is inside the building.

FIG. 7 is a plan view showing a space including door D and wall W as viewed from above and shows an example of the movable range of the door that opens outward and rightward. When closed door D is opened in the direction of arrow O to the position of door D′ shown in FIG. 7, the movable range of door D is inside movable range line A that forms a semicircular shape having its center at the position of hinge H of door D and a radius equal to the length of the door in a horizontal direction.

FIG. 8 is a plan view showing a space including door D and wall W as viewed from above and shows an example of the movable range of the door that opens outward and leftward. When closed door D is opened in the direction of arrow O to the position of door D′ shown in FIG. 8, the movable range of door D is inside movable range line A that forms a semicircular shape having its center at the position of hinge H of door D and a radius equal to the length of the door in a horizontal direction.

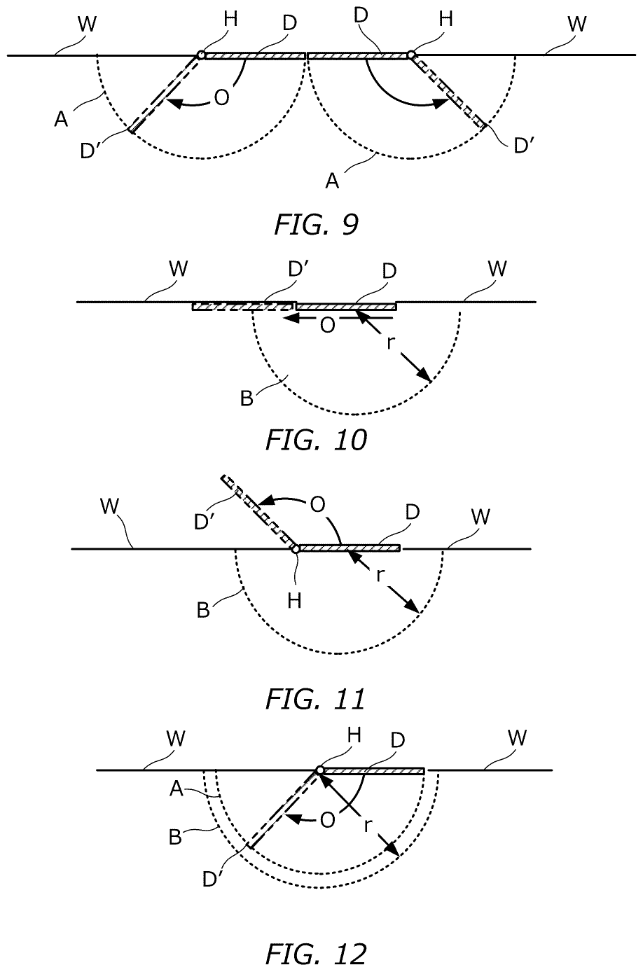

FIG. 9 is a plan view showing a space including doors D and wall W as viewed from above and shows an example of movable ranges of the doors that open outward and leftward and rightward respectively. When each of closed doors D is opened in the direction of arrow O to the position of corresponding door D′ shown in FIG. 9, the movable ranges of doors D are inside movable range lines A that form two semicircular shapes having their centers at the positions of hinges H of doors D and a radius equal to the length of each door in a horizontal direction.

Referring back to FIG. 4, setting unit 14 sets a prohibited entry range for drone 10 with reference to the position of the door. More specifically, when it is estimated by estimation unit 12 that there is a person inside of the door, setting unit 14 sets the prohibited entry range larger than when it is estimated that there is no person inside of the door. Furthermore, when it is estimated by estimation unit 12 that the person inside of the door will come outside of the door, setting unit 14 sets the prohibited entry range larger than when it is estimated that the person will not come outside of the door.

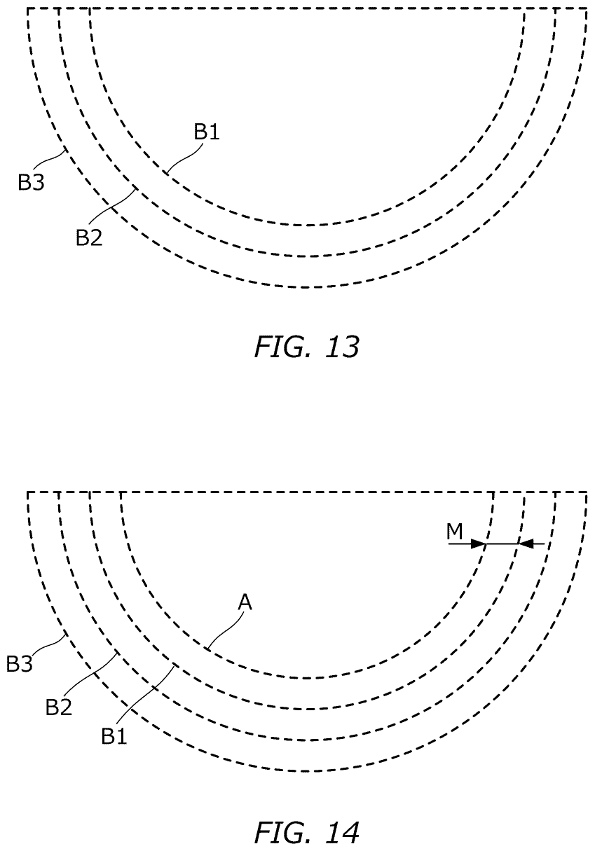

FIG. 10 is a diagram showing an example of the prohibited entry range of a case where the door is a sliding door as shown in FIG. 6. In this case, the prohibited entry range is inside prohibited entry line B that forms a semicircular shape having its center in a center portion of closed door D in a horizontal direction and a radius r that is at least half the length of the door in the horizontal direction. This prohibited entry line B is set according to whether or not there is a person inside of the door and whether or not the person will come outside of the door. Specifically, as shown in FIG. 13, when it is estimated that there is no person inside of the door, prohibited entry line B1 that defines the smallest prohibited entry range is set. When it is estimated by estimation unit 12 that there is a person inside of the door and the person will not come outside of the door, prohibited entry line B2 that defines a medium prohibited entry range is set. When it is estimated by estimation unit 12 that there is a person inside of the door and the person will come outside of the door, prohibited entry line B3 that defines the largest prohibited entry range is set.

FIG. 11 is a diagram showing an example of the prohibited entry range of a case where the door opens inward as shown in FIG. 7. Similarly to the case of the sliding door, the prohibited entry range in this case is inside prohibited entry line B that forms a semicircular shape having its center in a center portion of closed door D in a horizontal direction and a radius r that is at least half the length of the door in the horizontal direction. This prohibited entry line B is set as shown in FIG. 13 according to whether or not there is a person inside of the door and whether or not the person will come outside of the door.

FIG. 12 is a diagram showing an example of the prohibited entry range of a case where the door opens outward as shown in FIG. 8. In this case, the prohibited entry range is inside prohibited entry line B that forms a semicircular shape having its center at the position of hinge H of door D and a radius r equal to the length of the door in a horizontal direction. This prohibited entry line B is set according to whether or not there is a person inside of the door and whether or not the person will come outside of the door. Specifically, as shown in FIG. 14, when it is estimated that there is no person inside of the door, prohibited entry line B1 that defines the smallest prohibited entry range including at least the movable range of door D shown by movable range line A is set. At this time, it is desirable to provide certain margin M with respect to semicircular movable range line A because, if drone 10 flies just outside the movable range of the door or the parcel is placed just outside the movable range, for example, the user who comes out of the building by opening the door may collide with drone 10 or the parcel with momentum. When it is estimated by estimation unit 12 that there is a person inside of the door and the person will not come outside of the door, prohibited entry line B2 that defines a medium prohibited entry range is set. When it is estimated by estimation unit 12 that there is a person inside of the door and the person will come outside of the door, prohibited entry line B3 that defines the largest prohibited entry range is set.

Setting unit 14 sets a position within a predetermine distance (e.g., several tens of centimeters) from an outer edge (prohibited entry line B) of the prohibited entry range as a position at which the parcel delivered by drone 10 is to be placed. This is because a position that is outside the prohibited entry range and as close as possible to the door is appropriate as the position at which the parcel is to be placed, in view of the labor of the user collecting the parcel.

Referring back to FIG. 4, flight control unit 15 controls flight driving mechanism 1009 to cause drone 10 to land at the position set by setting unit 14 as the position at which the parcel is to be placed, and after drone 10 has landed, controls parcel loading mechanism 1010 to detach the parcel from drone 10, i.e., perform so-called unloading operations.

### Operations

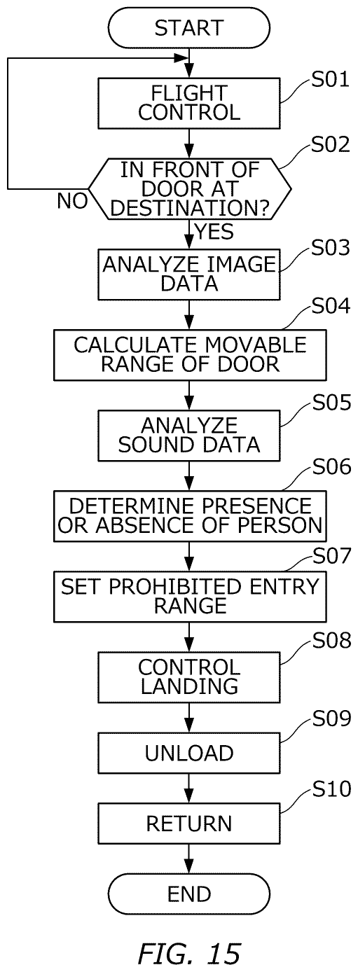

Next, the following describes processing performed during the flight of drone 10 with reference to the flowchart shown in FIG. 15. In FIG. 15, drone 10 starts to fly from the departure-arrival site to the destination and performs flight control in accordance with remote control performed by server apparatus 50 (step S01). Drone 10 flies to the sky above the destination whose address is specified when the delivery of a parcel is requested, under the control performed by server apparatus 50.

When drone 10 reaches the sky above the destination, drone 10 searches for a door provided at the destination by performing image recognition on image data obtained by an image sensor by capturing an image, for example, while gradually descending. When drone 10 arrives in front of the door (step S02: Yes), movable range calculation unit 13 analyzes image data obtained by the image sensor by capturing an image, with use of an analysis method such as pattern matching or feature value recognition, for example (step S03).

Then, movable range calculation unit 13 detects the appearance or the shape of the door included in the image data, recognizes door information regarding the door from the detection result, and calculates a movable range of the door (step S04).

Estimation unit 12 analyzes sound data obtained by obtaining unit 11 (step S05) and estimates whether or not there is a person inside of the door and whether or not the person inside of the door will come outside of the door (step S06). At this time, it is desirable that flight control unit 15 perform control to cause drone 10 to approach the movable range of door D as far as possible to perform detection with use of the sound sensor.

Then, setting unit 14 sets a prohibited entry range for which entry of drone 10 is prohibited based on the door information described above and the result of estimation performed by estimation unit 12 (step S07). Furthermore, setting unit 14 sets a position within the predetermine distance from an outer edge of the prohibited entry range as a position at which the parcel delivered by drone 10 is to be placed. Note that drone 10 approaches the movable range of door D as far as possible to detect sound with use of the sound sensor, but if drone 10 is inside the prohibited entry range when it is estimated by estimation unit 12 that there is a person inside of door D, flight control unit 15 immediately moves drone 10 to the outside of the prohibited entry range. That is to say, if drone 10 is flying inside the prohibited entry range when it is estimated that there is a person inside of door D, flight control unit 15 performs flight control to move drone 10 to the outside of the prohibited entry range.

Then, flight control unit 15 controls flight driving mechanism 1009 and parcel loading mechanism 1010 to cause drone 10 to land at the set position for placing the parcel (step S08) and perform unloading operations to detach the parcel from drone 10 (step S09). Flight control unit 15 performs flight control such that drone 10 will not collide with door D when drone 10 is flying or landing to place the parcel. That is to say, flight control unit 15 controls drone 10 to avoid a situation in which at least a part of drone 10 or the parcel enters the prohibited entry range during a period in which drone 10 is flying or landing to place the parcel. When the unloading operations are complete, drone 10 proceeds to processing for returning to the departure-arrival site (or moving to the next destination) (step S10).

According to the embodiment described above, when a person who is inside of a door comes outside of the door, it is possible to prevent the person from colliding with a flight vehicle that is outside the door.

### MODIFICATION EXAMPLES

The present invention is not limited to the embodiment described above. The embodiment described above may also be modified as described below. Also, two or more of the following modification examples may be combined.

### Modification Example 1

Estimation unit 12 may also estimate the height of a person who is inside of a door, and flight control unit 15 may also perform flight control in accordance with the estimation result. Specifically, estimation unit 12 calculates a distance from a floor surface to a position at which the voice of a person who is speaking is detected based on sound data obtained by a plurality of sound sensors, and adds a distance corresponding to a length from the mouth to the top of the head of the person to the calculated distance to estimate the height of the person inside of the door. If drone 10 is flying inside the prohibited entry range when it is estimated that there is a person inside of the door based on sound data, flight control unit 15 performs flight control based on the estimated height such that drone 10 moves in a direction that reduces the risk of collision with the person when drone 10 moves to the outside of the prohibited entry range. More specifically, flight control unit 15 performs flight control such that the higher the estimated height is, the more horizontal movement of drone 10 to the outside of the prohibited entry range is prioritized than vertical movement of drone 10 to the outside of the prohibited entry range. For example, when the height of the person is 180 cm, flight control unit 15 moves drone 10 away from the door at a speed of 50 cm/sec in the vertical direction and a speed of 100 cm/sec in the horizontal direction. If the height of the person is 140 cm, flight control unit 15 moves drone 10 away from the door at a speed of 100 cm/sec in the vertical direction and a speed of 50 cm/sec in the horizontal direction. Such a correspondence between the height of a person and a ratio between a speed of vertical movement and a speed of horizontal movement when drone 10 is moved to the outside of the prohibited entry range is stored in estimation unit 12 in advance. According to this modification example, when a person comes out through the door, it is possible to cause drone 10 to retract in accordance with the height of the person.

### Modification Example 2

Estimation unit 12 may also estimate a speed at which a person who is inside of a door will come outside of the door, and flight control unit 15 may also perform flight control in accordance with the estimation result. Specifically, estimation unit 12 estimates the sex or age of a person who is speaking inside of the door based on sound data obtained by a sound sensor and estimates a speed at which the person will come outside of the door based on the estimated age. In this case, the correspondence between the sex or age of a person and a speed at which the person will come outside of the door, e.g., the speed is the highest if the person is a male teenager, and the speed is the lowest if the person is a woman who is seventy years old or older, is stored in estimation unit 12 in advance. If drone 10 is flying inside the prohibited entry range when it is estimated that there is a person inside of the door based on sound data, flight control unit 15 performs flight control based on the estimated speed such that drone 10 moves in a direction that reduces the risk of collision with the person when drone 10 moves to the outside of the prohibited entry range. More specifically, flight control unit 15 performs flight control such that the higher the estimated speed is, the more horizontal movement of drone 10 to the outside of the prohibited entry range is prioritized than vertical movement of drone 10 to the outside of the prohibited entry range. For example, when the speed at which the person will come outside of the door is the highest speed, flight control unit 15 moves drone 10 away from the door at a speed of 50 cm/sec in the vertical direction and a speed of 100 cm/sec in the horizontal direction. When the speed at which the person will come outside of the door is the lowest speed, flight control unit 15 moves drone 10 away from the door at a speed of 100 cm/sec in the vertical direction and a speed of 50 cm/sec in the horizontal direction. According to this modification example, when a person comes out through the door, it is possible to cause drone 10 to retract in accordance with the speed at which the person comes out through the door.

### Modification Example 3

Estimation unit 12 may also estimate whether or not there is a person inside of a door together with an animal such as a pet, and flight control unit 15 may also perform flight control in accordance with the estimation result. Specifically, estimation unit 12 estimates whether or not there is a person inside of the door together with an animal other than the person by analyzing the presence or absence of a sound unique to the animal, such as a pet, and a sound generated due to action, based on sound data obtained by a sound sensor. If there is a person together with an animal such as a pet, the person may abruptly come outside of the door by being pulled by the pet, for example. Accordingly, if drone 10 is flying inside the prohibited entry range when it is estimated that there is a person inside of the door based on sound data, flight control unit 15 performs flight control based on the estimation result such that drone 10 moves in a direction that reduces the risk of collision with the person when drone 10 moves to the outside of the prohibited entry range. More specifically, flight control unit 15 performs flight control such that, in a case where it is estimated that there is also an animal other than the person inside of the door, horizontal movement of drone 10 to the outside of the prohibited entry range is prioritized over vertical movement of drone 10 to the outside of the prohibited entry range, compared with a case where it is estimated that there is only the person inside of the door. For example, when it is estimated that there is also an animal other than the person inside of the door, flight control unit 15 moves drone 10 away from the door at a speed of 50 cm/sec in the vertical direction and a speed of 100 cm/sec in the horizontal direction. When it is estimated that there is only the person inside of the door, flight control unit 15 moves drone 10 away from the door at a speed of 100 cm/sec in the vertical direction and a speed of 50 cm/sec in the horizontal direction. According to this modification example, it is possible to cause drone 10 to retract in accordance with the presence or absence of an animal such as a pet together with a person inside of the door.

### Modification Example 4

The larger the number of people who are inside of a door is, the higher the possibility of those people colliding with drone 10 is when they come outside of the door. Therefore, estimation unit 12 may also estimate the number of people who are inside of the door, and setting unit 14 may also set the prohibited entry range such that the larger the number of people inside of the door is, the larger the prohibited entry range becomes. Specifically, estimation unit 12 estimates the number of people who are inside of the door by analyzing a feature value such as the frequency of sound based on sound data obtained by a sound sensor. A correspondence between the number of people who are inside of a door and a size of the prohibited entry range is stored in setting unit 14 in advance, and setting unit 14 sets the prohibited entry range to a size corresponding to the estimated number of people. According to this modification example, it is possible to set the prohibited entry range in accordance with the number of people who are inside of the door.

### Modification Example 5

Estimation unit 12 may also estimate a speed at which a person who is inside of a door will come outside of the door, and setting unit 14 may also set a position at which a parcel is to be placed by drone 10 such that the higher the estimated speed is, the farther the position is away from the door. Specifically, estimation unit 12 estimates the sex or age of a person who is speaking inside of the door based on sound data obtained by a sound data and estimates a speed at which the person will come outside of the door based on the estimated age. In this case, the correspondence between the sex or age of a person and a speed at which the person will come outside of a door, e.g., the speed is the highest if the person is a male teenager, and the speed is the lowest if the person is a woman who is seventy years old or older, is stored in estimation unit 12 in advance. Setting unit 14 sets the position at which a parcel is to be placed by drone 10 such that the higher the estimated speed is, the farther the position is away from the door. According to this modification example, the position at which a parcel is to be placed can be set in accordance with the speed at which a person will come outside of the door.

### Modification Example 6

Environmental sound such as noise varies depending on the destination. Accordingly, drone 10 may also include a learning unit that learns features of environmental sound for each destination, and estimation unit 12 may also estimate whether or not there is a person inside of a door based on a detection result of the above-described sound obtained outside the door provided at the destination and features of environmental sound learned regarding the destination by the learning unit. In this case, it is possible to estimate the presence or absence of a person based on sound data detected outside the door without being affected by environmental sound such as noise in the vicinity of the door.

### Modification Example 7

In the embodiment described above, movable range calculation unit 13 recognizes door information regarding a door from a detection result of the appearance or the shape of the door based on image data obtained by capturing an image with use of an image sensor. The data used to detect the appearance or the shape of the door is not limited to image data, and it is also possible to use data obtained with use of various detection technologies, such as light detection and ranging (Lidar), for example.

### Modification Example 8

In the embodiment described above, movable range calculation unit 13 recognizes door information regarding a door from a detection result of the appearance or the shape of the door based on image data obtained by capturing an image with use of an image sensor. However, the method for identifying door information is not limited to that described in the above embodiment. For example, a configuration is also possible in which a wireless apparatus is provided at a predetermined position on the door provided at the destination, the wireless apparatus transmits door information regarding the door, and drone 10 receives the door information. At this time, the position of the door may be estimated based on a received electric field strength of the time when radio waves are received by drone 10. For example, the position of a wireless apparatus that emits radio waves can be identified relatively precisely as a position relative to a wireless apparatus that receives the radio waves, with use of a radio technology that is called Ultra-Wide Band (UWB). As described above, movable range calculation unit 13 may also calculate a movable range of the door based on door information regarding the door, which is provided in a wireless manner at the destination. In this case, it is possible to obtain more accurate door information (in particular, door information regarding the opening/closing mechanism) when compared with a case where the door information is obtained based on the appearance or the shape of the door.

### Modification Example 9

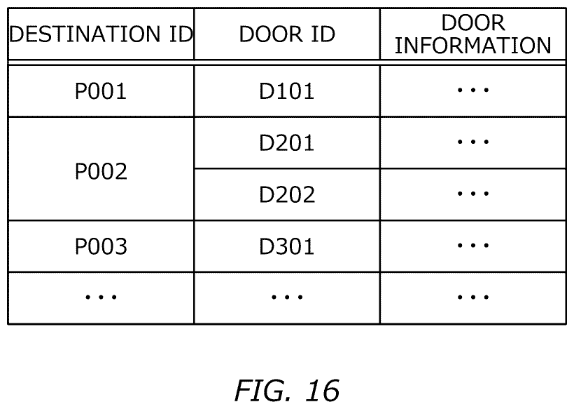

A configuration is also possible in which door information is stored in advance in association with identification information of the destination or the door, and the door information is identified with reference to the stored information. FIG. 16 is a diagram showing an example of door information stored in server apparatus 50. Server apparatus 50 reads out door information corresponding to an ID of the destination of drone 10 or a door provided at the destination, and transmits the door information to drone 10 via wireless communication network 40, and thus drone 10 obtains the door information and calculates a movable range of the door. As described above, movable range calculation unit 13 may also calculate a movable range of the door based on door information stored in association with identification information of the destination or the door. In this case, it is possible to obtain more accurate door information (in particular, door information regarding the opening/closing mechanism) when compared with a case where the door information is obtained based on the appearance or the shape of the door.

### Modification Example 10

Drone 10 may also be controlled by so-called edge computing (control performed by the drone) or cloud computing (control performed by the server apparatus) described in the embodiment, or a combination of these (control performed by the drone and the server apparatus). Accordingly, the control apparatus according to the present invention may also be included in server apparatus 50 disclosed in the embodiment.

### Modification Example 11

The flight vehicle in the present invention is not limited to an unmanned flight vehicle that is called a drone, and may also be a flight vehicle having any structure or form. Also, drone 10 unloads a parcel by landing at the destination, but may also deliver the parcel to the destination by a method other than landing (e.g., by dropping or suspending the parcel).

### Other Modifications

The block diagrams used for description of the above-described embodiment show blocks of the functional units. These functional blocks (configuration units) are realized by a suitable combination of hardware and/or software. Furthermore, means for realizing the functional blocks is not particularly limited. That is, each functional block may be realized by a single apparatus that is physically and/or logically put together, or by two or more apparatuses that are separated physically and/or logically from each other, and are connected to each other directly and/or indirectly (for example, in a wired manner and/or wireless manner).

The aspects/embodiments described in the present specification may be applied to a system that employs an appropriate system such as Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-Wide Band (UWB), Bluetooth (registered trademark), and/or to a next-generation system that is expanded based thereon.

The order of steps of the processing procedure, sequence, flowchart, and the like of the aspects/embodiments described in the present specification may be changed as long as there is no contradiction. For example, the method described in the present specification presents various step elements in an exemplified order, and is not limited to the presented specific order. The aspects/embodiments described in the present specification may be used alone or in combination, or may be used by being switched at the time of execution. Also, notification of predetermined information (for example, notification of “the fact that it is X”) is not limited to explicitly-executed notification, and may also include implicitly-executed notification (for example, notification of predetermined information is not executed).

The information, parameters, and the like described in the present specification may be expressed in absolute values, or may be expressed in relative values from a predetermined value, or may be expressed by other corresponding types of information.

The term “determining” used in the present specification may encompass various types of operations. The term “determining” may include, for example, judging, calculating, computing, processing, deriving, investigating, looking up (e.g., looking up a table, database, or another data structure), and ascertaining, which are regarded as “determining”. Also, the term “determining” may also include, for example, receiving (e.g., receiving information), transmitting (e.g., transmitting information), inputting, outputting, and accessing (e.g., accessing data stored in a memory), which are regarded as “determining”. Furthermore, the term “determining” may also include, for example, resolving, selecting, choosing, establishing, comparing, and the like, which are regarded as “determining”. In other words, the term “determining” may include, for example, any operation that is regarded as “determining”.

The present invention may also be provided as an information processing method or a program. Such a program may be provided in an aspect in which it is recorded in a recording medium such as an optical disc, or in an aspect in which it is downloaded, via a network such as the Internet, onto a computer and is installed so as to be available.

Software, an instruction, and the like may also be transmitted/received via a transmission medium. For example, if software is transmitted from a web site, a server, or another remote source, using wired technology such as a coaxial cable, an optical fiber cable, a twist pair, and a digital subscriber line (DSL), and/or wireless technology such as infrared light, a radio wave, and a microwave, the wired technology and/or the wireless technology will be included in the definition of the transmission medium.

Information, signals, and the like described in the present specification may also be expressed using any of various different technologies. For example, data, an instruction, a command, information, a signal, a bit, a symbol, a chip, and the like that may have been mentioned throughout the description above may also be expressed by an electric voltage, an electric current, an electromagnetic wave, a magnetic field or a magnetic particle, an optical field or a photon, or an arbitrary combination thereof.

Any reference to the elements using nominal signs such as “first” and “second” used in the present specification does not limit, in general, the amount or order thereof. These nominal signs can be used in the present specification as a convenient method for distinguishing between two or more elements. Accordingly, reference to first and second elements does not mean that only two elements can be used here, or that the first element should precede the second element somehow.

The “means” used for the configuration of each of the above-described apparatuses may be replaced by a “unit”, “circuit”, “device”, or the like.

The terms “including”, “comprising”, and any form thereof are intended to be comprehensive as long as they are used in the present specification or the claims, similar to the term “being provided with”. Furthermore, the term “or” used in the present specification or the claims is intended not to be exclusive OR.

In the entirety of the present disclosure, when articles, such as “a”, “an”, and “the” in English for example, are added through translation, these articles also denote the plural form unless it is clear otherwise from the context.

While the present invention has been described in detail, it would be obvious to those skilled in the art that the present invention is not limited to the embodiment explained in the present specification. The present invention can be implemented as corrected and modified aspects without departing from the spirit and scope of the present invention that are defined by the description of the claims. Accordingly, the present specification aims to illustrate examples and is not intended to restrict the present invention in any way.

### REFERENCE SIGNS LIST

1: Drone control system;
10: Drone;
11: Obtaining unit;
12: Estimation unit;
13: Movable range calculation unit;
14: Setting unit;
15: Flight control unit;
30: User terminal;
40: Wireless communication network;
50: Server apparatus;
1001: Processor;
1002: Memory;
1003: Storage;
1004: Communication apparatus;
1005: Input apparatus;
1006: Output apparatus;
1007: Positioning apparatus;
1008: Sensor;
1009: Flight driving mechanism;
1010: Parcel loading mechanism;
50: Server apparatus;
5001: Processor;
5002: Memory;
5003: Storage;
5004: Communication apparatus;
D, D′: Door;
H: Hinge;
W: Wall;
O: Direction;
A: Movable range line;
B, B1, B2, B3: Prohibited entry line; and
M: Margin

1. A control apparatus comprising:
an obtaining unit configured to obtain a result of sound detection outside a door situated at a destination of a flight vehicle;
an estimation unit configured to estimate whether a person is inside of the door based on the obtained result of sound detection; and
a setting unit configured to set a prohibited entry range for the flight vehicle based on a position of the door,
wherein, when it is estimated that the person is inside of the door, the setting unit increases the prohibited entry range compared to when it is estimated that there is no person inside of the door.

2. The control apparatus according to claim 1,
wherein the estimation unit estimates whether the person inside of the door comes outside of the door based on the obtained result of sound detection, and
when it is estimated that the person inside of the door comes outside of the door, the setting unit increases the prohibited entry range compered to when it is estimated that the person inside of the door does not come outside of the door.

3. The control apparatus according to claim 2,
wherein the estimation unit recognizes speech content of the person inside of the door based on the obtained result of sound detection, and estimates whether the person comes outside of the door based on the speech content.

4. The control apparatus according to claim 1, further comprising:
a movable range calculation unit configured to calculate a movable range within which the door opens and closes,
wherein the estimation unit performs the estimation based on the result of sound detection obtained while the flight vehicle is flying within a predetermined distance from an outer edge of the calculated movable range, and
the control apparatus further comprises a flight control unit configured to perform flight control to move the flight vehicle that is flying inside the prohibited entry range to an outside of the prohibited entry range when it is estimated that the person is inside of the door based on the sound.

5. The control apparatus according to claim 4,
wherein the estimation unit estimates a height of the person inside of the door, and
the flight control unit performs flight control based on the estimated height to move the flight vehicle in a direction that reduces a risk of collision with the person when the flight vehicle moves to the outside of the prohibited entry range.

6. The control apparatus according to claim 4,
wherein the estimation unit estimates a speed at which the person inside of the door comes outside of the door, and
the flight control unit performs flight control based on the estimated speed to move the flight vehicle in a direction that reduces a risk of collision with the person when the flight vehicle moves to the outside of the prohibited entry range.

7. The control apparatus according to claim 4,
wherein the estimation unit estimates whether both the person and an animal other than the person are inside of the door, and
the flight control unit performs flight control based on a result of the estimation to move the flight vehicle in a direction that reduces a risk of collision with the person when the flight vehicle moves to the outside of the prohibited entry range.

8. The control apparatus according to claim 1,
wherein the estimation unit estimates a number of people inside of the door, and
the setting unit increases the prohibited entry range as the number of people inside of the door increases.

9. The control apparatus according to claim 1,
wherein the flight vehicle delivers a parcel to the destination,
the estimation unit estimates a speed at which the person inside of the door comes outside of the door, and
the setting unit sets a position at which the flight vehicle places the parcel to a position farther away from the door as the estimated speed increases.

10. The control apparatus according to claim 1, further comprising:
a learning unit configured to learn a feature of environmental sound for each destination,
wherein the estimation unit estimates, based on a result of sound detection obtained outside of a door situated at a destination and a feature of environmental sound learned for the destination by the learning unit, whether a person is inside of the door.
